(19) United States
(12) Patent Application Publication
(10) Pub. No.: US 2008/0100588 A1
(43) Pub. Date: May 1, 2008

(54) TACTILE-FEEDBACK DEVICE AND METHOD

(75) Inventors: Atsushi Nogami, Tokyo (JP); Naoki Nishimura, Tokyo (JP); Toshinobu Tokita, Yokohama-shi (JP); Yoshihiko Iwase, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/877,444

(22) Filed: Oct. 23, 2007

(30) Foreign Application Priority Data
Oct. 25, 2006 (JP) 2006-290085

(51) Int. Cl. G06F 3/041

(52) U.S. Cl. 345/173

(57) ABSTRACT

A tactile-feedback device configured to enable a user to perceive a state of contact with a virtual object includes a plurality of stimulation generating units attached to a user body and a control unit configured to cause the plurality of stimulation generating units to generate stimulations different from each other when the user body is in contact with different surfaces of the virtual object.

### BACKGROUND OF THE INVENTION

1. Field of the Invention

The present invention relates to a tactile-feedback device configured to enable a user to perceive a state of contact with a virtual object in a virtual space, and also relates to a method for controlling the tactile-feedback device.

2. Description of the Related Art

The research and development in the field of virtual reality have introduced a tactile display technology that enables a user to touch or operate a virtual object. The tactile displays can be roughly classified into haptic displays (force-feedback displays) that present a reaction force from an object to a user body and tactile displays that present the touch and feel of an object.

However, conventional haptic display systems are large in size (i.e., poor in portability), complicated in structure, and expensive in cost. Conventional tactile display systems are also complicated in structure and are not yet sufficiently capable of presenting the feel of an object to a user.

In this respect, instead of presenting a sufficient reaction force from a virtual object or accurate feel of an object surface, it may be useful to provide a tactile-feedback device capable of simply presenting a state of contact between a user body and a virtual object.

This conventional tactile-feedback device provides plural vibration motors on a user body and enables a user to perceive a state of contact with a virtual object, if the user touches the virtual object, by actuating a corresponding vibration motor. With the vibration of a vibration motor, the user can identify a portion of his/her body which touches the object.

Vibration motors are generally compact, non-expensive, and lightweight, and therefore can be readily installed on a human body. In this respect, usage of vibration motors is effective in a virtual reality system excellent in mobility, which controls an interaction between a user body and a virtual object.

There are conventional tactile-feedback devices employing vibration motors. As discussed in PCT Japanese Translation Patent Publication No. 2000-501033 corresponding to U.S. Pat. No. 6,088,017 (hereinafter, referred to as Patent Document 1), a conventional device provides vibration motors on a data glove configured to obtain the position of a fingertip and vibrate if the fingertip contacts a virtual object, and thereby enables a user to perceive a state of contact between the fingertip and the virtual object.

As discussed in Yano et al.: “Development of Haptic Suit for whole human body using vibrators”, Virtual Reality Society of Japan paper magazine, Vol. 3, No. 3, 1998 (hereafter, referred to as Document 1), a conventional device includes a total of 12 vibration motors provided on a user body and configured to vibrate when the user body contacts a virtual wall and thereby enables a user to perceive the wall.

A human body sensory diagram in the Non-Patent Document 1 indicates that the vibration motors are positioned on the head, the back of each hand, each elbow, the waistline (three pieces), each knee, and each ankle.

As discussed in Jonghyun Ryu et al.: “Using a Vibrotactile Display for Enhanced Collision Perception and Presence”, VRST'04, Nov. 10-12, 2004, Hong Kong (hereafter, referred to as Document 2), a conventional device includes four vibration motors provided on an arm and a foot and configured to change vibration and thereby enables a user to perceive the different feel of an object.

As discussed in R. W. Lindeman et al.: “Towards full-Body Haptic Feedback: The Design and Deployment of a Spatialized Vibrotactile Feedback System”, VSRT'04, Nov. 10-12, 2004, Hong Kong (hereafter, Document 3), a conventional battlefield simulation system provides vibration motors on a human body and realizes a wireless control of the vibration motors.

FIG. 16 illustrates a configuration example of an existing tactile-feedback system using a plurality of vibration motors 301 on a user body and a head-mounted display 300 that a user can put on the head. The head-mounted display 300 is configured to present virtual objects to the user. This system further includes a predetermined number of position detecting markers 302 attached to the user body and a camera 6 installed at an appropriate location in the real space. The camera 6 is configured to obtain positional information of the user body based on the detected positions of respective markers 302.

The markers 302 are, for example, optical markers or image markers. Instead of using the markers 302, the tactile-feedback system may employ magnetic sensors that can obtain position/shape information of a user body. It is also useful to employ a data glove including optical fibers.

An information processing apparatus 310 includes a position detecting unit 303 configured to process image information captured by the camera 6 and obtain the position of a user body, a recording apparatus 304 configured to record position/shape information of each virtual object, an image output unit 307 configured to transmit a video signal to the head-mounted display 300, a position determining unit 305 configured to obtain a positional relationship between a virtual object and the user body, and a control unit 306 configured to control each vibration motor 301 according to the positional relationship between the virtual object and the user body.

With the above-described configuration, the information processing apparatus 310 detects position/orientation information of a user, determines a portion of a user body that is in contact with a virtual object, and activates the vibration motor 301 positioned closely to a contact portion. The vibration motor 301 transmits stimulation (vibration) to the user body and thereby enables a user to perceive a portion of the user body that is in contact with the virtual object.

FIG. 17 illustrates an exemplary relationship between a user body 1 and a virtual object 2 which are in contact with each other. The user body 1 (i.e., a hand and an arm) is equipped with a plurality of vibration motors 301. The vibration motors 301, each functioning or operating as a stimulation generating apparatus, are disposed around the hand and the arm. The user body 1 is in contact with different surfaces of the virtual object 2.

FIG. 18 is a cross-sectional view illustrating an exemplary state of the user body 1 illustrated in FIG. 17. The user body 1, indicated by an elliptic shape, is a forearm around which a total of four vibration motors 311 to 314 are disposed at equal angular intervals. When a left side of the forearm contacts the virtual object 2 as illustrated in FIG. 18, a tactile-feedback device activates a corresponding vibration motor 313 that transmits stimulation 21 to the user body 1 (i.e., the forearm). With the stimulation 21 caused by the vibration motor 313, a user equipped with the tactile-feedback device can perceive the contact between the left side of his/her forearm and the virtual object 2.

FIG. 19 illustrates an exemplary state where the left side of the user body 1 is in contact with one surface of the virtual object 2 while the bottom side is in contact with the other surface of the virtual object 2. In this case, the tactile-feedback device activates two (i.e., left and bottom) vibration motors 313 and 312 each transmitting the stimulation 21 to the user body 1. The user can perceive the contact with the virtual object 2 at two portions (i.e., left and bottom sides) of his/her forearm.

According to the example of FIG. 19, the user body 1 receives the same stimulation 21 from two (left and bottom) sides. A user can determine the portions where the user body 1 is in contact with the virtual object 2. However, the user cannot accurately determine the shape of the virtual object 2.

Namely, when the vibration motor 312 and the vibration motor 313 transmit the same stimulation, a user cannot discriminate a state where the user body 1 is in contact with two surfaces as illustrated FIG. 19 from a state where the user body 1 is in contact with a single surface as illustrated in FIG. 20.

The above-described conventional device uses vibration motors that generate simple stimulation which does not transmit a haptic force to a user body. Therefore, a user cannot determine the directivity in a state of contact.

For example, between the contact with two surfaces illustrated in FIG. 19 and the contact with a single surface illustrated in FIG. 20, a user cannot identify the shape of a virtual object which is in contact with the user body if the stimulation is tactile. In this case, a user determines the shape of a virtual object with reference to visual information. If no visual information is available, a user cannot perceive the shape of a virtual object.

The above-described problem arises when stimulation actuators are vibration motors or when tactile displays are attached to a user body. On the other hand, an apparatus including a plurality of haptic displays enables a user to determine whether a user body is in contact with plural points based on directions of reaction forces from respective contact points of a virtual object. The stimulation based on the tactile display can use only skin stimulation and cannot present the directivity of the stimulation. Therefore, a user cannot determine the direction of a contact.

### SUMMARY OF THE INVENTION

Exemplary embodiments of the present invention are directed to a tactile-feedback device having a simple configuration and capable of presenting a state of contact between a user body and a virtual object.

Furthermore, exemplary embodiments of the present invention are directed to a tactile-feedback device that does not possess the capability of presenting a haptic force. The tactile-feedback device according to the exemplary embodiments includes stimulation generating units configured to generate only skin stimulation and determine the shape of space/object.

According to an aspect of the present invention, a tactile-feedback device configured to enable a user to perceive a state of contact with a virtual object includes a plurality of stimulation generating units attached to a user body, and a control unit configured to cause the plurality of stimulation generating units to generate stimulations different from each other when the user body is in contact with different surfaces of the virtual object.

According to another aspect of the present invention, a tactile-feedback device configured to enable a user to perceive a state of contact with a virtual object includes a stimulation generating unit attached to a user body, and a control unit configured to determine stimulation generated by the stimulation generating unit according to a direction normal to a virtual object surface at a position where the user body is in contact with the virtual object.

According to yet another aspect of the present invention, a method for enabling a user to perceive a state of contact with a virtual object includes detecting a state of contact between a user body and a virtual object, and causing a plurality of stimulation generating units attached to the user body to generate stimulations different from each other when the user body is in contact with different surfaces of the virtual object.

According to yet another aspect of the present invention, a method for enabling a user to perceive a state of contact with a virtual object includes detecting a state of contact between a user body and a virtual object, and causing a stimulation generating unit attached to the user to generate stimulation determined according to a direction normal to a virtual object surface at a position where the user body is in contact with the virtual object.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 illustrates an example tactile-feedback device according to a first exemplary embodiment.

FIG. 2 illustrates an exemplary state of a user body that is in contact with only one surface of a virtual object.

FIG. 3 illustrates an exemplary state of a user body that is in contact with two different surfaces of a virtual object.

FIGS. 4A to 4C illustrate exemplary stimulations generated by stimulation generating units in various cases where a user body is in contact with one or plural surfaces of a virtual object.

FIG. 5 illustrates exemplary stimulation patterns different from each other.

FIG. 6 illustrates a plurality of stimulation generating units that can express a state of contact between the user body and a single surface.

FIG. 7 illustrates exemplary stimulations differentiated in period.

FIG. 8 illustrates exemplary stimulations differentiated in amplitude.

FIG. 9 illustrates exemplary stimulation generating units capable of generating electric stimulation and mechanical stimulation.

FIG. 10 illustrates an exemplary virtual object including surfaces being preset.

FIG. 11 illustrates an exemplary virtual object having a polygonal configuration.

FIGS. 12A and 12B illustrate an exemplary stimulation control performed considering a direction normal to a virtual object surface.

FIGS. 13A and 13B illustrate an exemplary state of fingers that are in contact with a curved surface of a virtual object.

FIG. 14 illustrates an exemplary stimulation control using contact depth information.

FIG. 15 is a flowchart illustrating an operation of an information processing apparatus.

FIG. 16 illustrates a general tactile-feedback device using vibration motors.

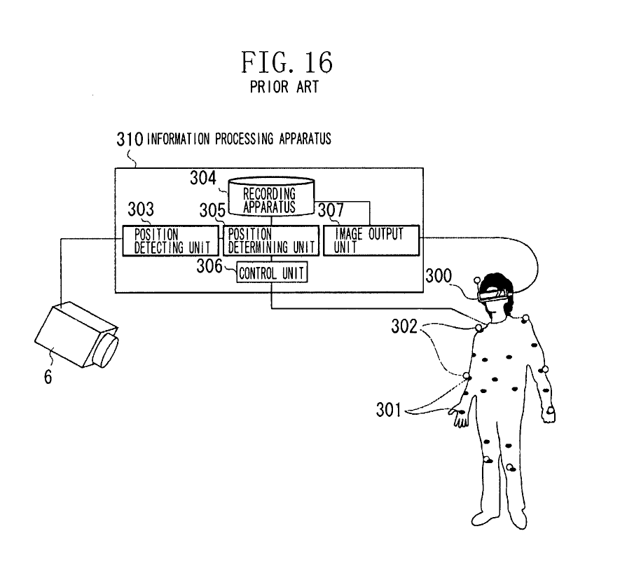

FIG. 17 illustrates an exemplary positional relationship between a user body and a virtual object.

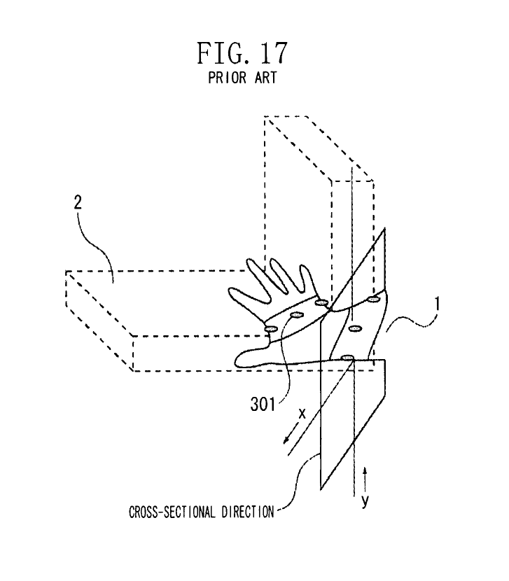

FIG. 18 illustrates an exemplary state of a user body that is in contact with only one surface of a virtual object.

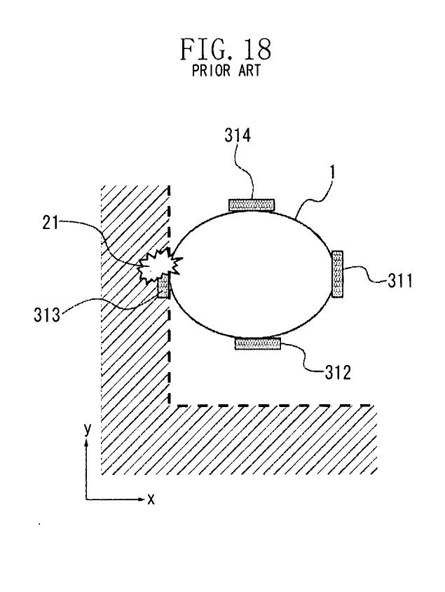

FIG. 19 illustrates an exemplary state of a user body that is in contact with two surfaces of a virtual object.

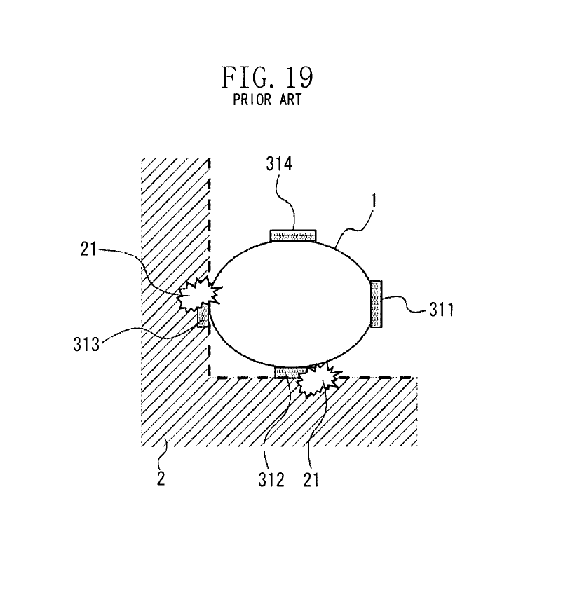

FIG. 20 illustrates an exemplary state of a user body that is in contact with a slant surface of a virtual object.

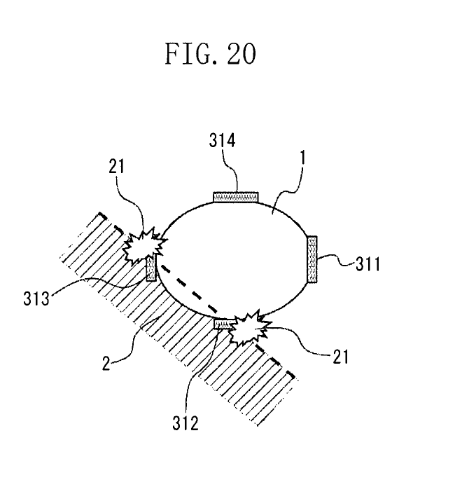

### DETAILED DESCRIPTION OF THE EMBODIMENTS

The following description of exemplary embodiments is illustrative in nature and is in no way intended to limit the invention, its application, or uses. Processes, techniques, apparatus, and systems as known by one of ordinary skill in the art are intended to be part of the enabling description where appropriate. It is noted that throughout the specification, similar reference numerals and letters refer to similar items in the following figures, and thus, once an item is described in one figure, it may not be discussed for following figures.

Various exemplary embodiments of the present invention are described below with reference to the drawings.

### First Exemplary Embodiment

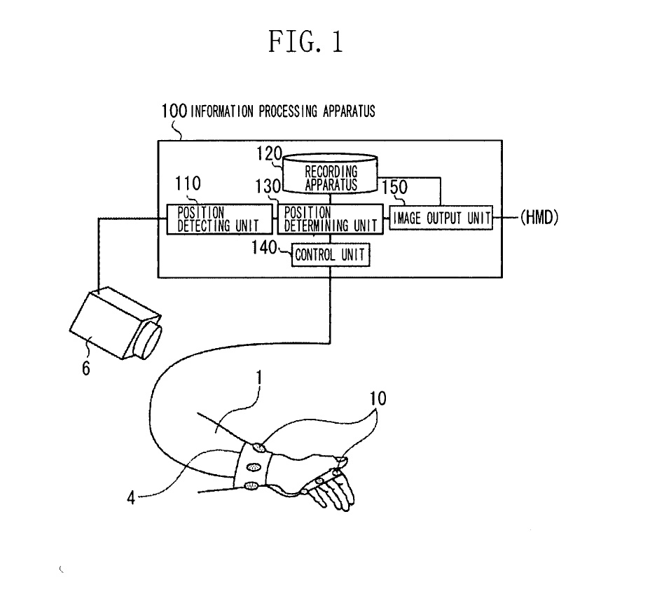

FIG. 1 illustrates a tactile-feedback device according to a first exemplary embodiment. The tactile-feedback includes a plurality of stimulation generating units 10 which are attached to a user body 1 with a fitting member 4. The fitting member 4 is, for example, a rubber band that is easy to attach to or detach from the user body 1 or any other member capable of appropriately fitting the stimulation generating units 10 to the user body 1.

The first exemplary embodiment disposes four stimulation generating units 10 around a wrist at equal intervals and four stimulation generating units 10 around a palm at equal intervals. However, the number of the stimulation generating units 10 is not limited to a specific value. A user can attach the stimulation generating units 10 to any places (e.g., fingertips, legs, and the waist) of the user body 1.

The stimulation generating units 10 are, for example, compact and lightweight vibration motors that can be easily attached to the user body 1 and configured to generate sufficient stimulation. However, the stimulation generating units 10 are not limited to vibration motors. The stimulation is not limited to vibratory stimulation or other mechanical stimulation and may be electric stimulation or thermal stimulation that can be transmitted to the skin nerve.

To transmit stimulation to the skin nerve, the mechanical stimulation unit may use a voice coil, a piezoelectric element, or a high-polymer actuator which may be configured to drive a pin contacting a user body, or use a pneumatic device configured to press a skin surface. The electric stimulation unit may use a microelectrode array. The thermal stimulation unit may use a thermo-element.

Still referring to FIG. 1, an information processing apparatus 100 is a general personal computer that includes a central processing unit (CPU), memories such as a read only memory (ROM) and a random access memory (RAM), and an external interface. When the CPU executes a program stored in the memory, the information processing apparatus 100 can function as a position detecting unit 110, a position determining unit 130, and an image output unit 150. Furthermore, the information processing apparatus 100 includes a control unit 140 configured to activate each stimulation generating unit 10.

The image output unit 150 outputs image information to an external display unit that enables a user to view a virtual object displayed on a screen. The display unit is, for example, a liquid crystal display, a plasma display, a cathode-ray tube (CRT), a projector, or a head-mounted display (HMD).

Furthermore, in addition to the positional detection of a user body, it is useful to present the touch and feel of an object surface according to a positional relationship between an actual user body and a virtual object.

An exemplary method for detecting the position of a user body may use markers and a camera. Another exemplary method may detect the position of a user body by processing an image captured by a camera and obtaining position/shape information of the user body. Another exemplary method may use other sensors (e.g., magnetic sensors, acceleration/angular velocity sensors, or geomagnetic sensors) that can detect the position of a user body.

The information processing apparatus 100 illustrated in FIG. 1 processes an image captured by a camera 6 and obtains position/shape information of the user body 1. The information processing apparatus 100 includes the position detecting unit 110 configured to process the image information received from the camera 6. Furthermore, the recording apparatus 120 stores position/appearance/shape information of each virtual object.

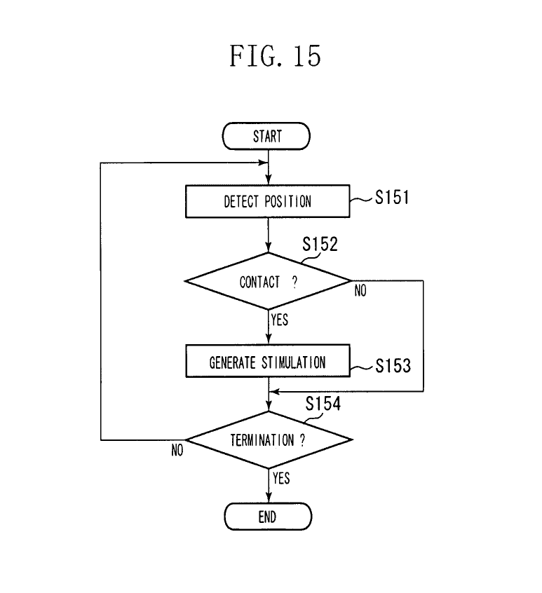

FIG. 15 is a flowchart illustrating an operation of the information processing apparatus 100. In step S151, the position detecting unit 110 detects the position of the user body 1 in a virtual space by comparing a measurement result of the user body 1 (i.e., positional information obtained from the image captured by the camera 6) with a user body model (i.e., user body avatar) prepared beforehand.

In step S152, the position determining unit 130 receives the positional information of the user body 1 from the position detecting unit 120 and determines a positional relationship between the user body 1 and a virtual object stored in the recording apparatus 120. According to the obtained relationship, the position determining unit 130 determines a distance between the user body 1 and a virtual object as well as the presence of any contact between them. Since these processes are realized by the conventional technique, a detailed description is omitted.

If there is any contact between the user body 1 and the virtual object (YES in step S152), then in step S153, the control unit 140 receives a result of contact determination from the position determining unit 130 and activates an appropriate stimulation generating unit 10 according to the determination result and thereby enables a user to perceive the contact with a virtual object. The information processing apparatus 100 repeats the above-described processing of steps S151 through S153 until a termination determination is made in step S154.

The control unit 140 performs the following control for driving the stimulation generating unit 10 that generates stimulation when the user body 1 is in contact with a virtual object.

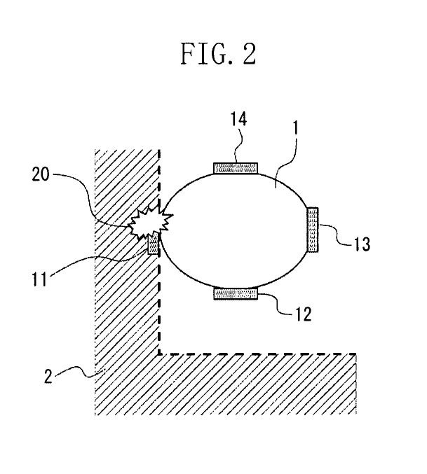

FIG. 2 is a cross-sectional view illustrating an exemplary state of the user body 1 that is in contact with only one surface of the virtual object 2. In FIG. 2, the user body 1 (i.e., forearm) has left, bottom, right, and top sides on which four stimulation generating units 11 to 14 (i.e., vibration motors) are disposed. The user body 1 is in contact with the virtual object 2 at the left side. In this state, the tactile-feedback device activates the left stimulation generating unit 11 (i.e., vibration motor closest to the contact portion) to transmit stimulation 20 to the user body 1. The generated stimulation 20 enables a user to perceive the contact with the virtual object 2 at the left side corresponding to the stimulation generating unit 11.

The user body 1 may contact the virtual object 2 at a portion deviated or far from the stimulation generating unit 11. If no stimulation generating unit is present near a contact position, the tactile-feedback device activates a stimulation generating unit closest to the contact position and thereby enables a user to roughly identify the position where the user body 1 is in contact with the virtual object 2. If the number of the stimulation generating units is large, the tactile-feedback device can accurately detect each contact position. However, the total number of the stimulation generating units actually used is limited because of difficulty in fitting, calibrating, and controlling a large number of stimulation generating units.

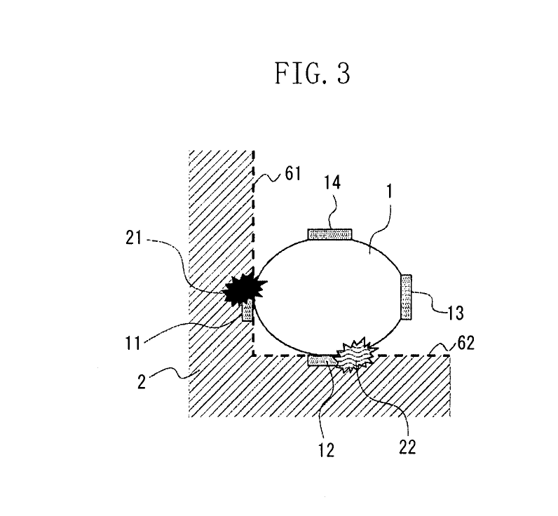

FIG. 3 illustrates an exemplary state of the user body 1 that is in contact with two different surfaces 61 and 62 of the virtual object 2. In the example of FIG. 3, the tactile-feedback device activates the stimulation generating unit 11 and the stimulation generating unit 12 (i.e., vibration motors adjacent to two contact portions) to transmit two types of stimulations 21 and 22 to the user body 1. Namely, the tactile-feedback device causes the stimulation generating unit 11 and the stimulation generating unit 12 to generate two stimulations 21 and 22 different from each other. A user can perceive the contact with two different surfaces 61 and 62 of the virtual object 2. In this case, it is useful to let a user know beforehand that the tactile-feedback device can generate plural types of stimulations if the user body contacts different surfaces.

According the example illustrated in FIG. 3, two surfaces 61 and 62 are perpendicular (90°) to each other. When two surfaces 61 and 62 cross each other at an angle other than 0° or 180°, the tactile-feedback device can appropriately arrange the stimulations 21 and 22 (e.g., according to a crossing angle between two surfaces 61 and 62). For example, the tactile-feedback device can maximize the difference between two stimulations 21 and 22 when the crossing angle is about 90° and minimize the stimulation difference when the crossing angle is about 0° or 180°.

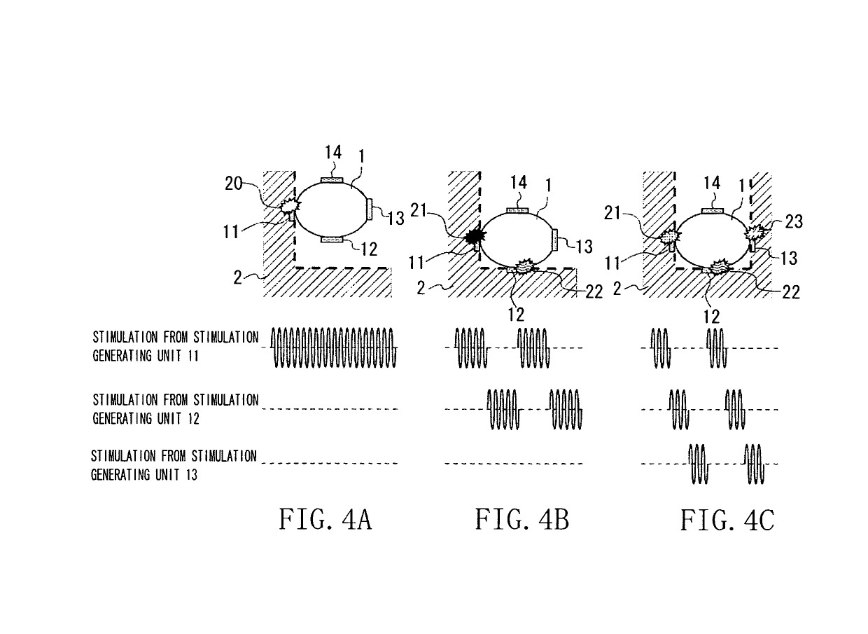

An exemplary tactile-feedback device may use mechanical vibratory stimulation that varies according to a state of contact. FIGS. 4A to 4C illustrate exemplary stimulations generated by stimulation generating units in various cases where the user body 1 is in contact with one or plural surfaces of the virtual object 2.

As illustrated in FIGS. 4A to 4C, the tactile-feedback device changes a vibration pattern of the stimulation generating unit according to a state of contact between the user body 1 and the virtual object 2.

FIG. 4A illustrates an exemplary state where only one surface of the virtual object 2 is in contact with the user body 1. The tactile-feedback device causes the stimulation generating unit 11 to transmit continuous stimulation 20 to the user body 1 while deactivating other stimulation generating units. In FIGS. 4A to 4C, the abscissa represents time and the ordinate represents vibration generated by the stimulation generating unit (vibration motor).

FIG. 4B illustrates an exemplary state where two surfaces of the virtual object 2 are simultaneously in contact with the user body 1. The tactile-feedback device causes the stimulation generating unit 11 and the stimulation generating unit 12 to generate stimulations 21 and 22 different from each other and thereby enables a user to perceive a state of contact with two different surfaces. In this case, the tactile-feedback device shifts a time the stimulation generating unit 11 generates the stimulation 21 relative to a time the stimulation generating unit 12 generates the stimulation 22. According to this stimulation pattern, a user can receive two types of stimulations 21 and 22 arriving from respective stimulation generating units 11 and 12 at different times. Thus, a user can determine that the user body 1 is in contact with different surfaces of the virtual object 2.

FIG. 4C illustrates an exemplary state where three surfaces of the virtual object 2 are simultaneously in contact with the user body 1. In this case, the tactile-feedback device causes the stimulation generating units 11, 12, and 13 to generate stimulations 21, 22, and 23 at different times.

The method for differentiating stimulations (vibrations) generated by respective stimulation generating units is not limited to the examples illustrated in FIGS. 4A to 4C. For example, instead of adjusting the stimulation time according to an increase in the number of contact surfaces, the tactile-feedback device can prepare a plurality of stimulation patterns beforehand and can select a desirable pattern according to the number of contact surfaces.

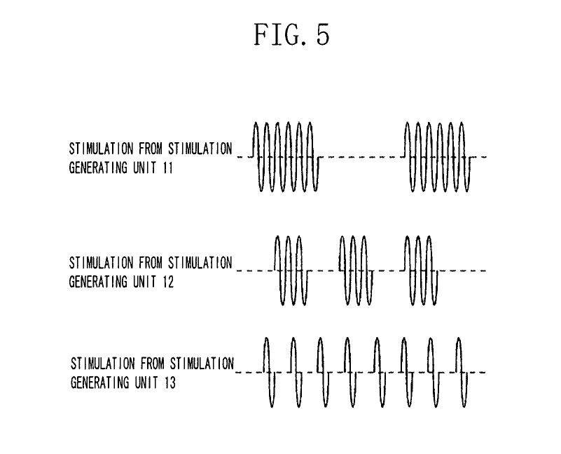

The tactile-feedback device can use any other type of vibration patterns as far as a user can determine a difference between stimulations generated by respective stimulation generating units. FIG. 5 illustrates exemplary vibration patterns of the stimulation generating units 11, 12, and 13, which are different in repetition pattern of vibration as well as start time of vibration and applicable to the above-described exemplary case of FIG. 4C. According to the vibration patterns illustrated in FIG. 5, a user can identify each of three stimulations generated by the stimulation generating units 11, 12, and 13 even when vibration times overlap with each other.

As described above, the tactile-feedback device can dynamically change the stimulation according to a state of contact between the user body 1 and the virtual object 2. However, as described later, the tactile-feedback device can set two or more surfaces on a virtual object beforehand and allocate a specific stimulation pattern to each surface.

In the above-described examples, when two or more surfaces of the virtual object 2 are simultaneously in contact with the user body 1, the tactile-feedback device causes corresponding stimulation generating units to generate different stimulations.

However, the tactile-feedback device can generate plural types of stimulations even when the user body 1 successively or sequentially contacts two or more surfaces of the virtual object 2 at different times. In such a case, it is useful to allocate specific stimulation beforehand or dynamically to the stimulation generating unit corresponding to each surface of a virtual object.

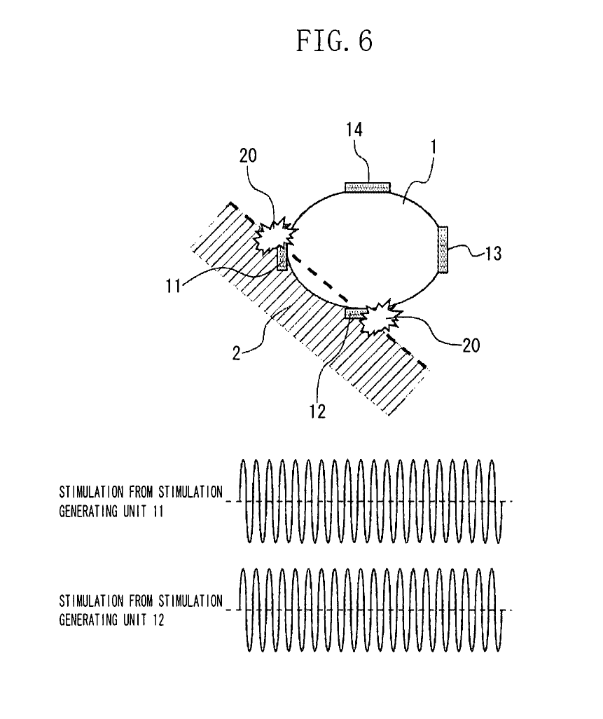

FIG. 6 illustrates two stimulation generating units 11 and 12 that can express a state of contact between the user body 1 and a single (slant) surface of the virtual object 2. In this case, the tactile-feedback device causes the stimulation generating units 11 and 12 to simultaneously generate the same stimulation. As the user body 1 receives no reaction force from the virtual object 2, the user body 1 may enter (overlap) the region occupied by the virtual object 2. As illustrated in FIG. 6, part of the user body 1 interferes with the virtual object 2. In the state of FIG. 6, the tactile-feedback device actuates the stimulation generating unit 11 and the stimulation generating unit 12 to let a user perceive a state of contact with the virtual object 2.

A contact surface to be expressed by the stimulation generating unit 11 is the same as a contact surface to be expressed by the stimulation generating unit 12. Therefore, the stimulation generating unit 11 and the stimulation generating unit 12 generate stimulations having the same pattern as illustrated in FIG. 6.

When the number of stimulation generating units is three or more, the tactile-feedback device controls the stimulation generating units in the same manner. For example, if the user body 1 completely overlaps with the virtual object 2 in FIG. 6, the tactile-feedback device causes all stimulation generating units 11 to 14 to generate the same stimulation.

As described above, the present exemplary embodiment controls the stimulation generating units according to two methods. One control method can express the contact with a single (i.e., the same flat) surface by causing the stimulation generating units to generate the same stimulation. The other control method can express the contact with two or more surfaces by causing the stimulation generating units to generate different stimulations. Thus, a user can identify the shape of a virtual object as well as a state of contact between the user body 1 and the virtual object 2.

The different stimulations letting a user perceive a state of contact with different surfaces are not limited to the above-described stimulation patterns. For example, the stimulations may be different in frequency or intensity.

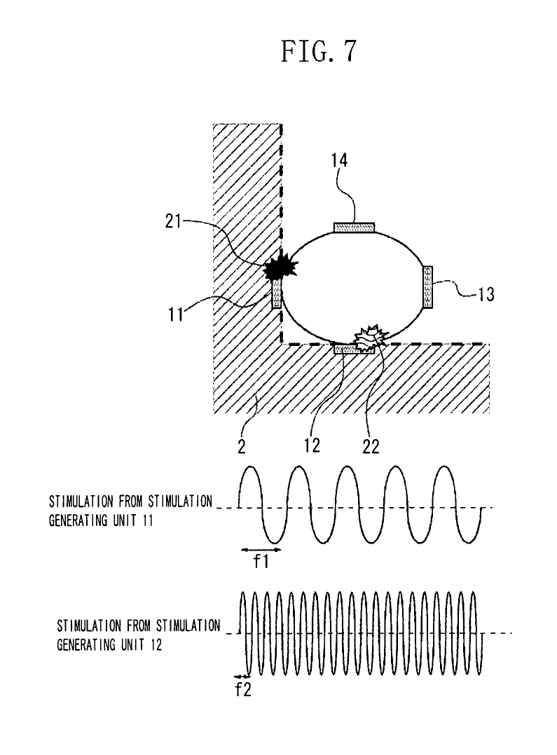

FIG. 7 illustrates exemplary stimulations whose frequencies are differentiated according to the contact surface. More specifically, the stimulation generating unit 11 generates vibratory stimulation at the period of f1. The stimulation generating unit 12 generates vibratory stimulation at the period of f2.

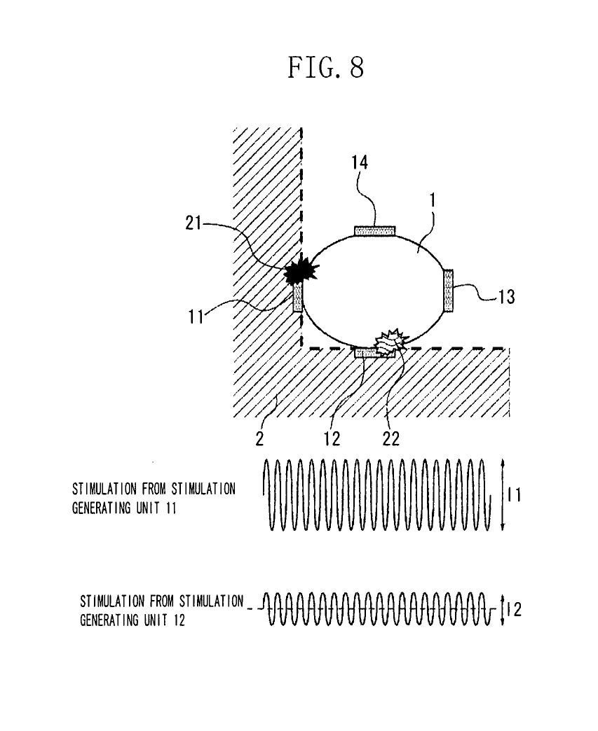

FIG. 8 illustrates exemplary stimulations whose amplitudes (intensities) are differentiated according to the contact surface. More specifically, the stimulation generating unit 11 generates vibratory stimulation having the amplitude of I1. The stimulation generating unit 12 generates vibratory stimulation having the amplitude of I2.

Furthermore, the stimulations may be different in combination of stimulation pattern, frequency, and intensity. With the stimulations modified in this manner, a user can perceive a great number of states of contact. The different stimulations can be generated according to a method other than the above-described methods which change at least one of vibration pattern, vibration intensity, and vibration frequency.

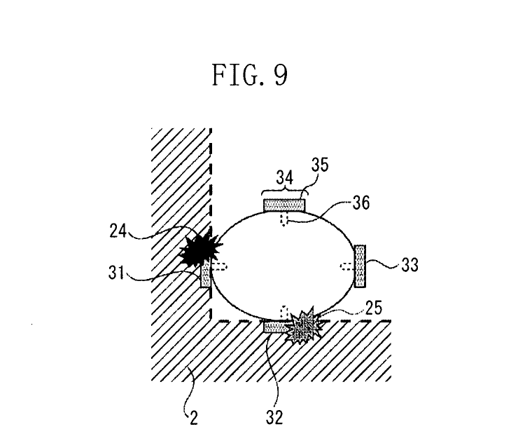

For example, the stimulation generating unit may be configured to select a method for transmitting predetermined stimulation to a user body according to a contact surface. FIG. 9 illustrates an exemplary state where two surfaces of the virtual object 2 are in contact with the user body 1. Each of stimulation generating units 31 to 34, attached to the user body 1, includes a combination of an electric stimulation generating unit 35 and a mechanical stimulation generating unit 36.

The electric stimulation generating unit 35 is, for example, a needle-like electrode. The mechanical stimulation generating unit 36 is, for example, a vibration motor. The stimulation generating unit 31 activates the electric stimulation generating unit 35 to transmit electric stimulation 24 to the user body 1. The stimulation generating unit 32 activates the mechanical stimulation generating unit 36 to transmit mechanical stimulation 25 to the user body 1. A user receives both the electric stimulation and the mechanical stimulation (i.e., different stimulations) and determines that the user body 1 is in contact with two surfaces of the virtual object 2.

In the above-described embodiments, two or more different surfaces cross each other at an angle of about 90°. The following is a definition of surfaces on which different stimulations are transmitted.

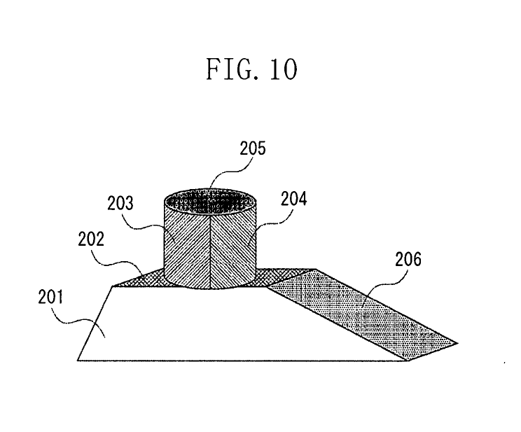

FIG. 10 illustrates an exemplary virtual object including preset surfaces to which different stimulations are transmitted. The virtual object illustrated in FIG. 10 has a polygonal shape which includes a columnar body put on a pedestal and six surfaces 201 to 206 being set beforehand. If a user body contacts two or more surfaces of the virtual object, the tactile-feedback device transmits plural types of stimulations to the user body.

The columnar body has a cylindrical side surface divided into two curved surfaces 203 and 204 as illustrated in FIG. 10. If the cylindrical side surface is divided into a large number of curved surfaces, a user can accurately perceive each curved surface.

The definition of surfaces to which different stimulations are transmitted is not limited to the above-described surfaces being preset. If a user body contacts a plurality of different polygons, the tactile-feedback device can perform control for generating different stimulations.

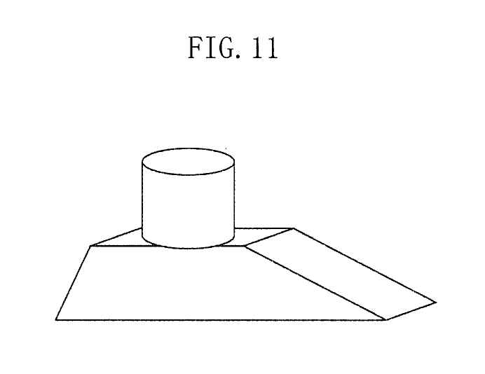

FIG. 11 illustrates a virtual object having a polygonal configuration. If the user body contacts plural polygons of the virtual object illustrated in FIG. 11, the tactile-feedback device performs control for generating different stimulations at respective contact points. The above-described method for defining different polygons as contact with different surfaces can be preferably used when a virtual object has a curved surface or a smaller number of polygons.

Furthermore, the above-described method for defining the surfaces which receive different stimulations can be combined with the method for generating different stimulations for respective polygons. For example, it is useful to regard continuous flat surfaces or portions having a smaller radius of curvature as the same flat surface beforehand and determine whether to generate the same stimulation or different stimulations according to the defined surface. On the other hand, if the radius of curvature is large, the tactile-feedback device generates different stimulations at the time the user body contacts different polygons.

### Second Exemplary Embodiment

A second exemplary embodiment is different from the first exemplary embodiment in a definition of different surfaces. A second exemplary embodiment calculates a direction normal to a virtual object surface at each point where the user body is in contact with a virtual object. If the directions normal to the virtual object surface are different, the tactile-feedback device generates different stimulations.

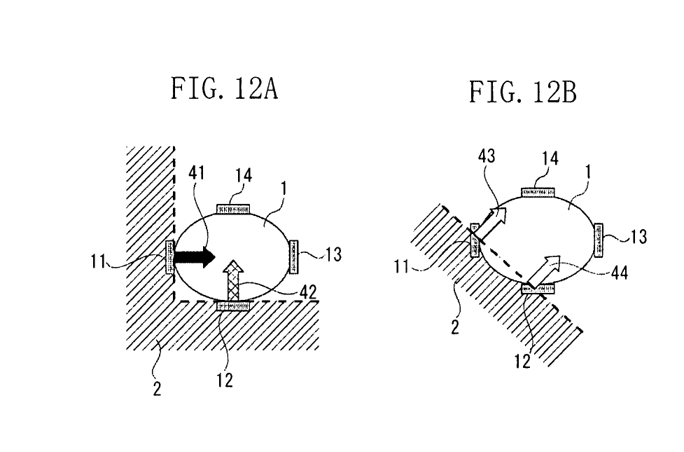

FIGS. 12A and 12B, corresponding to FIGS. 3 and 6 of the first exemplary embodiment, illustrate different surfaces defined based on directions normal to the virtual body surface. In both cases of FIGS. 12A and 12B, left and bottom sides of the user body 1 are in contact with the virtual object 2. The tactile-feedback device activates the stimulation generating units 11 and 12 to let a user perceive a state of contact between the user body 1 and the virtual object 2.

The tactile-feedback device obtains a direction normal to a virtual object surface at each contact point. According to the example of FIG. 12A, normal directions 41 and 42 at two contact points are perpendicular to each other. The tactile-feedback device determines that the contact points are on different surfaces and causes the stimulation generating units 11 and 12 to generate different stimulations.

According to the example of FIG. 12B, a direction 43 normal to the virtual object surface at one contact point is parallel to a direction 44 normal to the virtual object surface at the other contact point. The tactile-feedback device determines that the contact points are on the same surface (flat surface) and causes the stimulation generating units 11 and 12 to generate the same stimulation.

The tactile-feedback device may control the stimulation generating units to generate the same stimulation only when the normal directions are completely the same. Alternatively, the tactile-feedback device may cause the stimulation generating units to generate different stimulations if an angular difference between the normal directions is greater than a predetermined angle. The tactile-feedback device causes the stimulation generating units to generate the same stimulation if the angular difference between the compared normal directions is less than the predetermined angle.

In this manner, determining whether to generate different stimulations based on the directions normal to a virtual object surface at respective contact points requires no preliminary definition with respect to surfaces from which different stimulations are generated. The preparation for a tactile-feedback control becomes simple. Especially, this method can be preferably used when a user body may contact a curved surface.

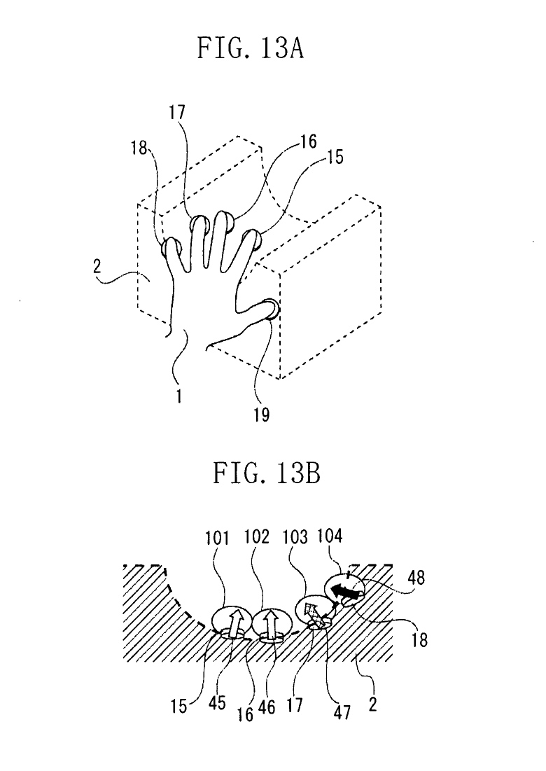

FIGS. 13A and 13B illustrate exemplary state of fingers in contact with a curved surface and a determination of stimulation based on a direction normal to the curved surface. In FIG. 13A, stimulation generating units 15 to 19 are attached to fingertips of the user body 1 which are respectively in contact with a curved surface (a concave surface) of the virtual object 2.

In the foregoing description, the stimulation generating units are attached to an arm or a palm. However, the stimulation generating units can be attached to any other portions of a user body. The stimulation generating units configured to generate different stimulations can be located to distant or spaced places (e.g., fingers illustrated in FIG. 13A).

FIG. 13B is a cross-sectional view of the exemplary state of FIG. 13A, which illustrates a forefinger 101, a middle finger 102, a third finger 103, and a little finger 104, together with stimulation generating units 15 to 18 attached to respective fingers and directions 45 to 48 normal to the curved surface of the virtual object 2 at respective contact points of the fingers.

The tactile-feedback device compares the normal directions 45 to 48 at the contact points of respective fingers, and determines stimulations to be generated by the stimulation generating units 15 to 18. In the present exemplary embodiment, if an angular difference between the compared directions exceeds a predetermined value, the tactile-feedback device causes the stimulation generating units to generate different stimulations.

For example, according to the example illustrated in FIGS. 13A and 13B, a difference between the directions 45 and 46 normal to the virtual object surface at the forefinger 101 and the middle finger 102 is within the predetermined angle. The stimulation generating units 15 and 16 generate the same stimulation. Furthermore, a direction 47 normal to the virtual object surface at a portion where the third finger 103 is in contact with the virtual object 2 inclines than the predetermined angle compared to the directions 45 and 46 normal to the virtual surface at the forefinger 101 and the middle finger 102. The stimulation generating unit 17 generates stimulation different from that of the stimulation generating units 15 and 16.

Furthermore, a direction 48 normal to the virtual object surface at a portion where the little finger 104 is in contact with the virtual object 2 differs from the above-described directions 45, 46, and 47. The stimulation generating unit 18 attached to the little finger 104 generates stimulation different from those of the stimulation generating units 15, 16, and 17.

The tactile-feedback device performing the above-described control enables a user to perceive the curved surface of the virtual object 2 illustrated in FIG. 13A.

The direction normal to a virtual object surface at a contact point of the user body can be defined, for example, by a normal vector of a polygon which is in contact with the user body. Furthermore, if the user body is in contact with plural polygons, the normal direction can be defined by an average of plural directions normal to respective polygons or a representative one of the normal directions.

Furthermore, if the tactile-feedback device determines a state of contact between a user body and a virtual object expressed using a free curved surface, such as non-uniform rational B-spline (NURBS) surface, the tactile-feedback device can directly obtain a normal direction at the contact point from the free curved surface.

If interference detection using a bounding box is feasible, the tactile-feedback device can use a normal direction of a bounding box surface at a contact point.

Similar to the first exemplary embodiment, respective stimulation generating units can generate stimulations different in stimulation pattern, stimulation intensity, and stimulation frequency. It is useful to relate each specific direction to specific stimulation beforehand.

The above-described exemplary embodiment defines (identifies) different surfaces according to the direction normal to a virtual object surface at respective contact points. It is also useful to use contact depth information in addition to the directional information. Namely, an exemplary tactile-feedback device can present both the direction of each contact surface and the depth of contact.

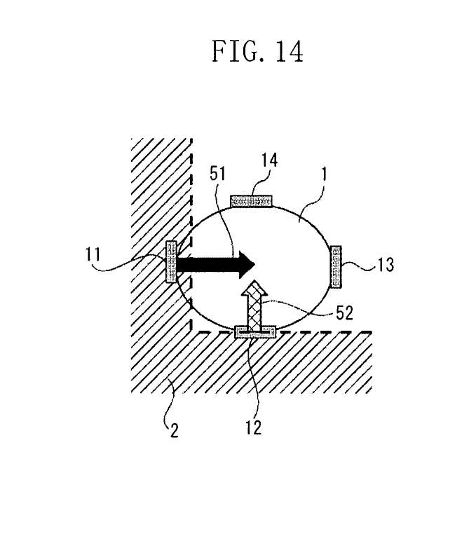

FIG. 14 illustrates an exemplary stimulation control using contact depth information. Similar to FIG. 3, FIG. 14 illustrates an exemplary state where two portions of the virtual object 2 are in contact with the user body 1 equipped with four stimulation generating units 11 to 14 disposed at four (i.e., right, left, top, and bottom) places in a circumferential direction.

The stimulation generating unit used in the present exemplary embodiment does not generate a haptic force (i.e., a reaction force from the virtual object 2). The user body 1 may interfere with the virtual object 2. According to the example of FIG. 14, the left part of the user body 1 interferes with (invades into) the virtual object 2 at a portion adjacent to the stimulation generating unit 11.

On the other hand, the bottom side of the user body 1 is slightly in contact with the virtual object 2 at a portion adjacent to the stimulation generating unit 12. The tactile-feedback device obtains an interference depth at each point where the user body is in contact with the virtual object in addition to a direction normal to the virtual object surface.

In FIG. 14, each vector represents a normal direction and an interference depth at a contact point. A vector 51 from a contact point corresponding to the stimulation generating unit 11 has a large scalar compared to that of a vector 52 from a contact point corresponding to the stimulation generating unit 12. A relationship between an amount of entry of the user body 1 into the virtual object 2 and a scalar of the vector can be calculated using the following spring model.

### F=−kΔx

### F: scalar (i.e., reaction force)

k: spring constant
Δx: amount of entry of the user body 1 into the virtual object 2

A method for calculating a force with respect to an amount of entry according to a spring model is generally referred to as “penalty method” which is a publicly known method for calculating a reaction force.

The tactile-feedback device can calculate the above-described scalar using a publicly known method including the penalty method, although not described in detail. The tactile-feedback device activates the stimulation generating units according to a vector representing both normal direction information and interference depth information.

If normal directions of compared contact points are different, the tactile-feedback device causes corresponding stimulation generating units to generate different stimulations. Furthermore, if interference depths at respective contact points are different, the tactile-feedback device causes the stimulation generating units to generate different stimulations.

More specifically, if the normal directions are different between compared contact points, the tactile-feedback device changes the pattern or frequency of stimulations. If the interference depths are different between compared contact points, the tactile-feedback device increases the intensity of stimulation according to the interference depth. In the example of FIG. 14, the stimulation generating unit 11 generates stimulation different in stimulation pattern and larger in intensity compared to that of the stimulation generating unit 12.

### Other Exemplary Embodiments

The present invention is also achieved by the following method. A recording medium (or storage medium) which records software program code to implement the functions of the above-described embodiments is supplied to a system or apparatus. The computer (or CPU or MPU) of the system or apparatus reads out and executes the program code stored in the recording medium.

In this case, the program code read out from the recording medium implements the functions of the above-described embodiments. The recording medium that records the program code constitutes the present invention.

When the computer executes the readout program code, the operating system (OS) running on the computer partially or wholly executes actual processing on the basis of the instructions of the program code, thereby implementing the functions of the above-described embodiments.

The program code read out from the recording medium is written in the memory of a function expansion card inserted to the computer or a function expansion unit connected to the computer. The CPU of the function expansion card or function expansion unit partially or wholly executes actual processing on the basis of the instructions of the program code, thereby implementing the functions of the above-described embodiments.

The recording medium to which the present invention is applied stores program code corresponding to the above-described flowcharts.

While the present invention has been described with reference to exemplary embodiments, it is to be understood that the invention is not limited to the disclosed exemplary embodiments. The scope of the following claims is to be accorded the broadest interpretation so as to encompass all such modifications, equivalent structures, and functions.

This application claims priority from Japanese Patent Application No. 2006-290085 filed Oct. 25, 2006, which is hereby incorporated by reference herein in its entirety.

What is claimed is:

1. A tactile-feedback device configured to enable a user to perceive a state of contact with a virtual object, the device comprising:
a plurality of stimulation generating units attached to a user body; and
a control unit configured to cause the plurality of stimulation generating units to generate stimulations different from each other according to the difference of surfaces of the virtual object being contact with the user body.

2. The tactile-feedback device according to claim 1, wherein the stimulations generated by the stimulation generating units are different in at least one of pattern, frequency, and intensity.

3. The tactile-feedback device according to claim 1, wherein the surfaces of the virtual object are surfaces divided and defined beforehand

4. The tactile-feedback device according to claim 1, wherein the surfaces are defined by different polygons of the virtual object.

5. A tactile-feedback device configured to enable a user to perceive a state of contact with a virtual object, the device comprising:
a stimulation generating unit attached to a user body; and
a control unit configured to determine stimulation generated by the stimulation generating unit according to a direction normal to a virtual object surface at a position where the user body is in contact with the virtual object.

6. The tactile-feedback device according to claim 5, wherein the control unit compares directions normal to the virtual object surface at a plurality of contact positions and differentiates stimulations to be generated by a plurality of stimulation generating units if an angular difference between the compared normal directions is larger than a predetermined angle.

7. A method for enabling a user to perceive a state of contact with a virtual object, the method comprising:
detecting a state of contact between a user body and a virtual object; and
causing a plurality of stimulation generating units attached to the user body to generate stimulations different from each other according to the difference of surfaces of the virtual object being contact with the user body.

8. A method for enabling a user to perceive a state of contact with a virtual object, the method comprising:
detecting a state of contact between a user body and a virtual object; and
causing a stimulation generating unit attached to the user to generate stimulation determined according to a direction normal to a virtual object surface at a position where the user body is in contact with the virtual object.
